(19) United States
(12) Patent Application Publication
(10) Pub. No.: US 2005/0202706 A1
(43) Pub. Date: Sep. 15, 2005

(54) Snap ring connector system

(76) Inventors: Neal Bonavia, Davie, FL (US); Mario Alvarez, Miami, FL (US)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 11/061,564

(22) Filed: Feb. 18, 2005

Related U.S. Application Data
(60) Provisional application No. 60/551,653, filed on Mar. 9, 2004.

(51) Int. Cl. H01R 13/62

(52) U.S. Cl. 439/296

(57) ABSTRACT

A resilient quick-connector system having an engagement force below a first threshold to facilitate manual engagement and a disengagement force between a second threshold and a third threshold. The disengagement force above the second threshold prevents manual or accidental disengagement. The disengagement force below the third threshold allows the connector system to disengage upon application of an excessive break-away force before damage to connected equipment occurs. A monolithic receptacle shell having snap arms engages a coupling sleeve adapted to retain a plug to the receptacle within the predetermined force thresholds. The receptacle shell and/or the coupling sleeve is mountable to substantially fixed equipment.

### CROSS REFERENCE TO RELATED APPLICATIONS

The present application claims the benefit of U.S. Provisional Application No. 60/551,653 filed on Mar. 9, 2004, which is incorporated herein by reference.

### FIELD OF THE INVENTION

The present invention relates to conduit connector systems and more particularly to a system and method for removable attachment of connector plugs to connector receptacles.

### BACKGROUND OF THE INVENTION

Connector systems providing mechanical engagement for immobilization and/or strain relief of conduit connections such as electrical, fiber optic, hydraulic and pneumatic connections are well known and used in a variety of configurations. Such connector systems typically allow manual engagement by threading, snapping or press fitting a plug into a receptacle and providing for manual disengagement by de-threading, unsnapping or pulling the plug from the receptacle.

Secondary latches or strain relief structures are used to secure connections and to prevent unintentional disconnection by requiring some secondary action to be performed for engagement and/or disengagement between a plug and a receptacle. Such secondary latches and strain relief structures are often spring-loaded and are commonly used, for example, in circular shell type connectors known in the art. An example of such a secondary structure can be seen in U.S. Pat. No. 6,517,373 wherein a sliding sleeve is actuated against a spring force to release locking tabs. These secondary latches and strain relief structures are commonly made using a numerous moving parts and therefore add complexity and expense to the connector system while reducing its durability. Accordingly it is desirable to provide a connector system having a substantially monolithic receptacle and coupling sleeve.

The threaded engagement sleeve used in circular connectors such as the connector system shown in U.S. Pat. No. 3,587,032 provides secure engagement between plug and receptacle but requires substantial effort to install and is unsuitable in some applications which require a quick- connect type engagement. An exemplary threaded engagement sleeve heretofore known is illustrated herein in FIG. 1 in which an internally threaded engagement sleeve 10 which retains a connector plug 12 is adapted for installation to the externally threaded body 14 of a flange-type receptacle 16. Since such connector systems can not be disengaged by application of a pulling force, they are unsuitable for applications wherein the connector must release by pulling to protect connected equipment from damage.

It is often desirable to manually make a connection between conduits wherein the connection is impossible or very difficult to manually disconnect but which must disconnect upon reaching a critical extraction force to protect connected equipment from damage. Such a connector system therefore requires an insertion/engagement force below a first threshold for manual insertion and an extraction/disengagement force above a second threshold to prevent manual disengagement but below a third threshold to allow disengagement before connected equipment is damaged by tension in the connected conduit. Such fine tuning of engagement/disengagement forces is not possible in many connector systems known in the art.

Accordingly, it is desirable to provide a connector system having an engagement force below a first threshold, and a disengagement force between a second and third force threshold. It is further desirable to control the engagement and disengagement force by minor manufacturing adjustments.

### SUMMARY OF THE INVENTION

The present invention provides a resilient quick-connector system having an engagement force below a first threshold to facilitate manual engagement and a disengagement force between a second threshold and a third threshold. The disengagement force above the second threshold prevents manual or accidental disengagement. The disengagement force below the third threshold allows the connector system to disengage upon application of an excessive break-away force before damage to connected equipment occurs. A monolithic receptacle shell having snap arms engages a coupling sleeve adapted to retain a plug to the receptacle within the predetermined force thresholds. Either the receptacle shell or the coupling sleeve is mountable to substantially fixed equipment.

An illustrative embodiment of the present invention provides a connector system including a receptacle having an annular wall defining a proximal opening, a distal opening and a central cavity extending from the proximal opening to the distal opening along a longitudinal axis. A mounting portion extends transversely from the annular wall. A radial array of snap arms is formed in the annular wall and extends distally around the distal opening. The illustrative embodiment also includes a coupling sleeve having an annular wall defining a proximal opening, a distal opening a central cavity extending from the proximal opening to the distal opening along a longitudinal axis. The coupling sleeve further includes an internal annular groove defining a step portion adapted for engagement with the snap arms of the receptacle.

In the illustrative embodiment, the receptacle further includes an insert retaining portion extending from the annular wall into the central cavity thereof. The coupling sleeve also includes an insert retaining portion extending from annular wall into the central cavity. A pin insert is durably mounted in the central cavity of the receptacle. A socket insert is durably mounted in the central cavity of the mounting sleeve.

In a particular embodiment of the present invention, the pin insert includes a set of connector pins protruding from a planar substrate. The socket insert includes a set of sockets protruding from a planar substrate and arranged for receiving the set of connector pins.

In an illustrative embodiment of the invention forces required to overcome snap forces and friction for engagement of the receptacle and pin insert to the coupling sleeve and socket insert are substantially less than forces to overcome snap forces and friction for disengagement of the receptacle and pin insert from the coupling sleeve and socket insert.

In a particular embodiment, force required to overcome snap forces and friction for engagement of the receptacle and pin insert to the coupling sleeve and socket insert are suitable for manual engagement therebetween and forces to overcome snap forces and friction for disengagement of the receptacle and pin insert from the coupling sleeve and socket insert are high enough to prevent manual disengagement therebetween.

In another particular embodiment, the force required to overcome snap forces and friction for engagement of the receptacle and pin insert to the coupling sleeve and socket insert is between about 15 lbs and about 30 lbs and forces to overcome snap forces and friction for disengagement of the receptacle and pin insert from the coupling sleeve and socket insert is between about 75 and about 110 lbs.

Another illustrative embodiment of the present invention further includes an annular groove extending into the snap arms and adapted to accept an o-ring. The o-ring groove depth is adapted to adjust snap engagement/extraction forces. In a particular embodiment, the snap arms include tapered lead-in surface such that the distal end external diameter of the radial array of snap arms is less than the proximal opening of the coupling sleeve. In a particular embodiment, the receptacle according the present invention is made from aluminum alloy.

In a more particular embodiment of the present invention, a connector system includes a receptacle having an annular wall defining a proximal opening, a distal opening and a central cavity extending from said proximal opening to the distal opening along a longitudinal axis. A mounting portion extends transversely from the annular wall. A radial array of snap arms is formed in the annular wall and extends distally around the distal opening. An insert retaining portion in the receptacle extends from the annular wall into the central cavity. A coupling sleeve includes an annular wall defining a proximal opening, a distal opening a central cavity extending from the proximal opening to the distal opening along a longitudinal axis, an internal annular groove defining a step portion adapted for engagement with the snap arms and an insert retaining portion extending from the annular wall into the central cavity. A pin insert is durably mounted in the central cavity of the receptacle and a socket insert is durably mounted in the central cavity of the mounting sleeve.

The pin insert includes a set of connector pins protruding from a planar substrate. The socket insert includes a set of sockets protruding from a planar substrate and is arranged for receiving the set of connector pins. The force required to overcome snap forces and friction for engagement of the receptacle and pin insert to the coupling sleeve and socket insert is about between 15-30 lbs. The forces required to overcome snap forces and friction for disengagement of the receptacle and pin insert from the coupling sleeve and socket insert is about between 75 and 110 lbs.

The present invention also provides a method of making a connector system by providing a receptacle having a mounting portion and a plurality of snap arms extending distally therefrom, durably installing a pin/socket insert in the receptacle, providing a coupling sleeve adapted for snapping over the plurality of snap arms and durably installing a socket/pin insert in the coupling sleeve.

In a particular embodiment, the inventive method also includes the steps of providing particular engagement/disengagement forces between the receptacle and the coupling sleeve by adjusting parameters of snap arms such as snap arm width, base thickness, ramp-depth, and step depth. Particular engagement/disengagement forces between said receptacle and said coupling sleeve can be achieved by controlling the depth of an o-ring groove wherein the o-ring groove intersects the snap arms. A particular embodiment of the inventive method also includes the steps of designing the snap arms and mating portions of the coupling sleeve to provide an engagement force between the receptacle and the coupling sleeve of about 25 lbs and a disengagement force between the receptacle and the coupling sleeve of about 80 lbs.

Another illustrative embodiment of the present invention provides a method of protecting connected equipment connected by electrical, hydraulic or pneumatic conduit. The illustrative method includes fixedly mounting a receptacle on the equipment wherein the receptacle permanently holds a first set of conduit terminals and durably installing a mating set of conduit terminals to a mounting sleeve. The mounting sleeve is configured as a snap ring adapted to snap fit to the receptacle with an engagement force low enough for manual installation of the sleeve to the receptacle and a disengagement force exceeding a manually achievable force. In a particular embodiment of the inventive method, the disengagement force exceeds the weight of the cables and equipment associated with the mating set of conduit terminals.

### BRIEF DESCRIPTION OF THE DRAWINGS

The foregoing and other features and advantages of the present invention will be more fully understood from the following detailed description of illustrative embodiments, taken in conjunction with the accompanying drawing in which:

FIG. 1 is a side elevation view of a threaded receptacle and a mating plug having a threaded coupling sleeve according to the PRIOR ART;

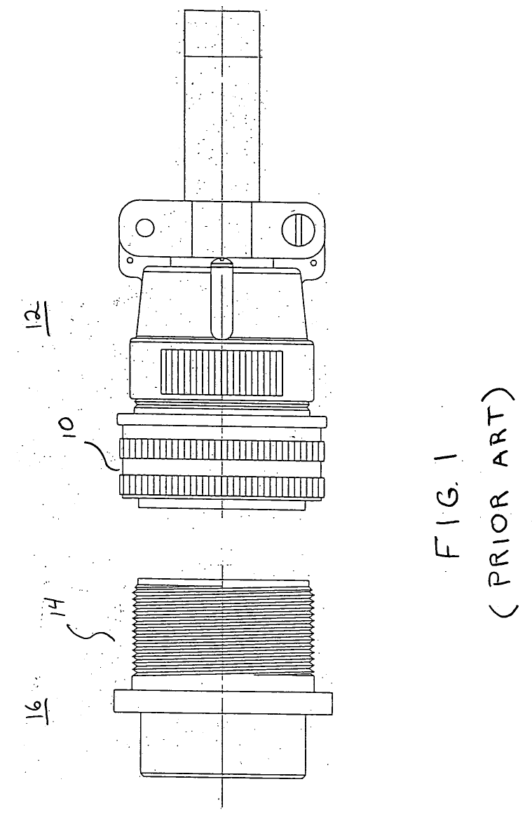

FIG. 2 is a side elevation view of a snap receptacle and mating plug having a coupling sleeve according to an illustrative embodiment of the present invention;

FIGS. 3A and 3B are side and front orthogonal views of a connector receptacle having a connector insert installed therein according to an illustrative embodiment of the present invention;

FIGS. 4A and 4B are front and side orthogonal views of a connector plug having a coupling sleeve installed thereon according to an illustrative embodiment of the present invention;

FIG. 5 is a side partial cross sectional view of a snap receptacle and coupling sleeve according to an illustrative embodiment of the present invention; and

FIG. 6 is a side partial cross sectional view of a snap receptacle and coupling sleeve showing certain snap dimensions according to exemplary embodiments of the present invention.

### DETAILED DESCRIPTION OF THE DRAWINGS

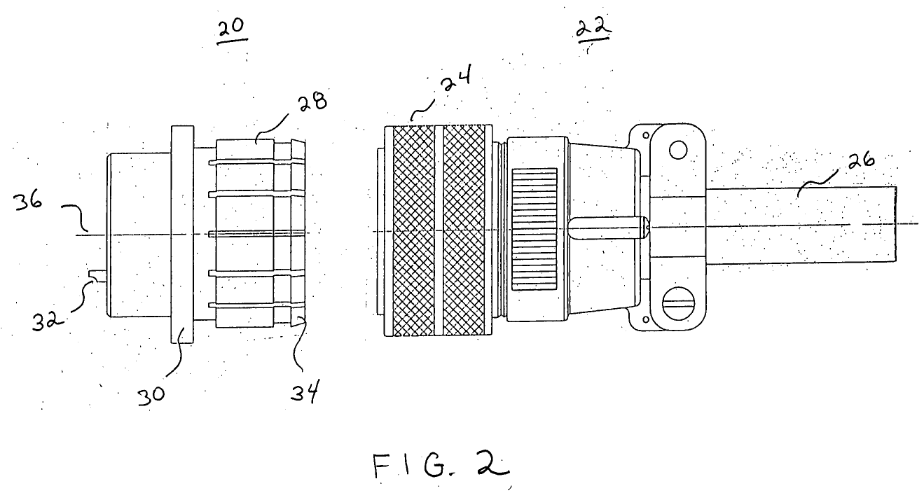

An illustrative embodiment of a connector coupling system according to the present invention is described with reference to FIG. 2. Throughout the present specification the term “proximal” is used to refer to the direction toward the receptacle side of a receptacle/plug connector system and the term “distal” is used to refer to the direction toward the plug side of a receptacle/plug connector system. A connector receptacle 20 is adapted for engagement with a mating connector plug 22. A coupling sleeve 24 attached to or engaged with the connector plug 22 translates over a plurality of snap arms 28 which extend from the connector receptacle 20. The coupling sleeve 24 includes an internal depression such as an annular groove (not shown) to receive an engagement portion 34 of snap arms 28. The snap arms 28 are typically arranged as a radial array.

A mounting flange 30 extends from the connector receptacle transverse to the longitudinal axis 36 thereof. The mounting flange provides means for attaching the connector receptacle 30 to a first piece of connected equipment (not shown).

A cable 26 extends from the connector plug and typically connects a second piece of connected equipment (not shown). The cable 26 can contain one or a plurality of conduits and conduit types for connection between the first and second pieces of equipment. For example, the cable may contain one type or a combination of types of conduits such as electrical wires, fiber optic cables, pneumatic lines, hydraulic lines and the like. In the illustrative embodiment shown in FIG. 2, a solder cup 32 extends from the receptacle to provide a permanent attachment point for an electrical wire.

Inserts (not shown) in both the connector plug 22 and receptacle 20 support and align a mating set of conduit terminals such connector pins and mating sockets.

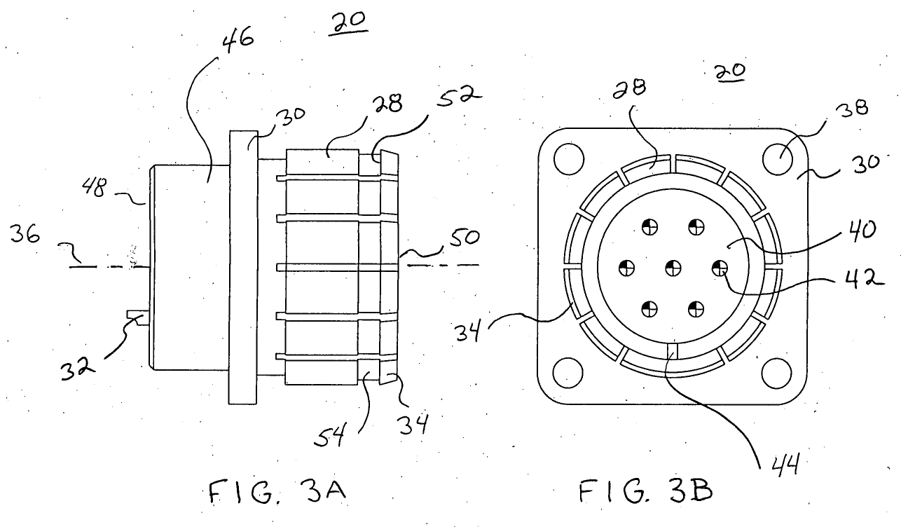

A connector receptacle 20 according to an illustrative embodiment of the present invention is described more particularly with reference to FIG. 3A and FIG. 3B in which FIG. 3A provides a side elevation view of a connector receptacle 20 and FIG. 3B provides a front elevation view of a connector receptacle 20.

The connector receptacle 20 comprises a substantially hollow cylindrical body 46 disposed about a longitudinal axis 36 and having a proximal opening 48 and a distal opening 50. A mounting portion such as a flange 20 extends radially from the body 46. In the illustrative embodiment, mounting holes 38 are provided through the flange to accept mounting hardware for securing the connector receptacle to a mounting surface (not shown).

A plurality of snap arms 28 are formed in the proximal end of the cylindrical body 46. In the illustrative embodiment, the snap arms 28 are configured in as a radial array surrounding the distal opening 50. An engagement surface such as a step 52 is formed in the snap arms to engage a mating surface such as a mating step in the coupling sleeve 24 (FIG. 2). In the illustrative embodiment the step 52 in each snap arm 28 is formed by an annular groove 54 formed in the external surface of the radial array of snap arms 28 near the proximal end thereof.

The connector receptacle 20 locates and secures at least one conduit terminal for alignment with a mating conduit terminal. In the illustrative embodiment, a plurality of conductor pins 42 are securely mounted through an insert 40 which is resiliently attached to the receptacle 20. Persons skilled in the art should understand that the insert 40 can be made from a variety of materials and attached in the internal surface of the receptacle body 40 by a variety of attachment means. In the illustrative embodiment, the insert 40 includes a peripheral groove which snapped over an annular rib (not shown) in the internal surface of receptacle body 40 and glued thereto.

The conductor pins have a mating portion extending distally from the insert 40 and an attachment portion extending proximally from the insert. The attachment portion can be adapted for removable attachment of conductors in connected equipment or for permanent attachment thereto. In the illustrative embodiment, an exemplary attachment portion of one conductor pin 42 is a solder cup 32 to which a conductor in the connected equipment can be permanently attached by a solder joint formed thereon. The proximal opening 48 provides access to the attachment portion of the conduit terminals. The distal opening 50 provides access to the mating portion of the conduit terminals.

An internally protruding axial rib in the receptacle body 46 provides a polarizing key 44 which is accepted into a polarizing keyway (not shown) in the a mating plug 22 (FIG. 2). The polarizing key 44 interferes with the coupling sleeve when the receptacle body is not properly rotationally oriented with the mating plug and prevents connection therebetween. Persons skilled in the art should appreciate that the polarizing key may alternatively be provided in the mating plug and a polarizing keyway formed in the receptacle body 46 without departing from the spirit and scope of the present invention. It should be understood that a variety of polarizing features known in the art can adapted to provide rotational alignment between a plug and receptacle as an alternative to the polarizing key 44 and keyway without departing from the spirit and scope of the present invention.

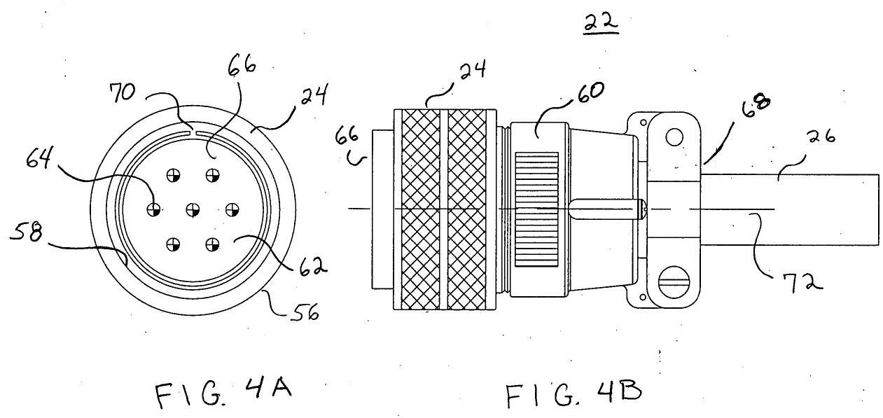

A coupling sleeve 24 assembled to a connector plug 22 according to an illustrative embodiment of the present invention is more particularly described with reference to FIG. 4A and FIG. 4B in which FIG. 4A is front elevation view of a connector plug assembly and FIG. 4B is a side elevation view of a connector plug assembly.

The coupling sleeve 24 comprises a cylindrical sidewall having an inner surface adapted for snap engagement with the receptacle 20 of the present invention (FIGS. 3A and 3B). The plug 22 includes a shell 60 which surrounds and supports an insert 62. The shell 60 has a proximal opening 66 and a distal opening 68. The insert 62 supports and orients at least one conduit terminal such as a conductive socket 64 adapted to engage a corresponding conduit terminal such as the conductor pin 42 in the receptacle 20 (FIG. 3A).

In the illustrative embodiment, a plurality of conductor sockets 64 are securely mounted through the insert 62 which is resiliently attached to the connector plug shell 60. Persons skilled in the art should understand that the insert 62 can be made from a variety of materials and attached in the internal surface of the shell 60 by a variety of attachment means. In the illustrative embodiment, the insert 62 includes a peripheral groove which snapped over an annular rib (not shown) in the internal surface of shell 60 and glued thereto.

The conductor sockets 64 have a mating portion extending proximally from the insert 62 and an attachment portion extending distally from the insert 62. In the illustrative embodiment, the attachment portion is adapted for permanent attachment to conduits in a cable 26 which extends through the distal opening of the shell 60. The cable 26 is clamped to the shell 60 to provide strain relief to the connections between conduits and conduit terminal at the attachment portion thereof. The proximal opening 66 provides access to the attachment portion of the conduit terminals. A polarizing keyway 70 is formed by a groove in proximal end of the shell 60 parallel to the longitudinal axis 72 thereof.

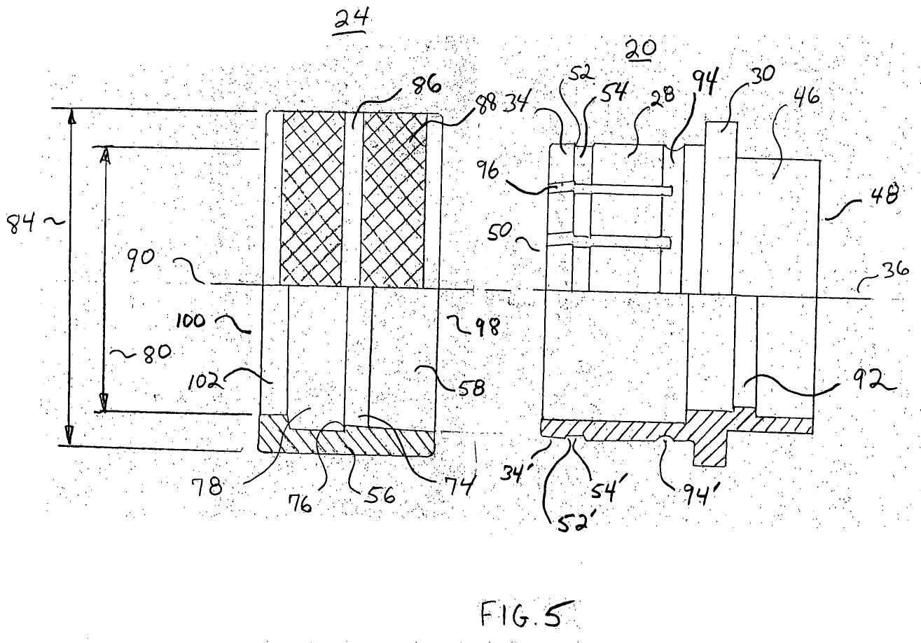

The coupling sleeve 24 is fitted over the connector plug shell 60 and coaxially aligned therewith. The coupling sleeve 24 can be fixed to the shell 60 or may be configured to allow some axial travel relative thereto. Engagement between the coupling sleeve 24 and connector plug shell 60 and engagement between coupling sleeve 24 and connector receptacle 20 is described in more detail with reference to FIG. 5.

FIG. 5 is a side partial cross sectional view of a coupling sleeve and a connector receptacle aligned for engagement therewith according to an illustrative embodiment of the present invention. Coupling sleeve 24 includes a substantially cylindrical sidewall 56 about a longitudinal axis 90. In the illustrative embodiment, the sidewall has an outer surface 86 including knurled portions 88 to facilitate manual gripping during installation of the sleeve 24 to a receptacle 20. The sidewall 56 defines a proximal opening 98, a distal opening 100 and an inner surface 58. The distal opening 98 includes a distal inner diameter 80 which is less than the diameter of internal portions of the coupling sleeve 24 because a back-wall ledge 102 is provided around the distal opening 100.

The back-wall ledge 102 limits axial travel of the coupling sleeve 24 in the proximal direction relative to a connector plug shell 60 (not shown). During assembly of the coupling sleeve 24 to a connector plug according to an illustrative embodiment of the invention, the plug shell 60 is installed through the proximal opening 98 of the coupling sleeve and extends partially through the distal opening 100. Portions of the coupling shell extend radially beyond the inside diameter 80 and are therefore engaged by the back-wall ledge 102.

A step 76 is formed by an internal annular groove 78 in the inner surface 58 of the coupling sleeve 24. When a receptacle 20 is engaged with the coupling sleeve 24 and latched thereto, a latching step 52 in the snap arm 28 of the receptacle abuts the step 76 in the coupling sleeve 24. Engagement between the two steps provides resistance from disengagement of the coupling sleeve from the connector receptacle 20. In the illustrative embodiment, an annular ramp 74 is formed in the inner surface 58 to increase the depth of step 76. The dimensions of the annular ramp can be chosen to compress the snap arms 28 by a particular amount at particular displacements during engagement and thereby tune the engagement force vs. displacement profile, for example, to provide a selected engagement force or tactile feedback of a positive engagement.

In the illustrative embodiment, steps 52 are formed in the snap arms 28 of the receptacle 20 by providing an external annular groove 54 in the radial array of snap arms. Snap arms are separated by longitudinal slots 96. Persons skilled in the art should appreciate that selection of a particular length and width of the longitudinal slots 96 can be performed as a means to adjust the mechanical characteristics of the snap arms and thereby to adjust the engagement and disengagement forces between coupling sleeve 24 and receptacle 20.

The distal end of snap arms 28 includes an engagement portion 34 such as a lead-in ramp in which the outside diameter of the distal end of the radial snap arm array is less than the inside diameter of the coupling sleeve proximal opening. Persons skilled in the art should understand that, in addition to providing a lead-in structure, the dimensions of engagement portion 34 ramp can also be selected to adjusted engagement and disengagement forces and to adjust the force vs. displacement profile of a coupling sleeve 24 to a receptacle 20.

In the illustrative embodiment, an o-ring groove 94 is provided around the proximal ends of snap arms 28. The o-ring groove intersects the longitudinal slots 96 and therefore also affects the snap force of snap arms 28 when engaging a coupling sleeve 24. Persons skilled in the art should understand that the selection of the o-ring groove dimensions, i.e. depth, radius and longitudinal location, can be used as another means of tuning the snap engagement force profile. An o-ring can optionally be provided therein to provide fluid sealing between the sleeve 24 and receptacle 20.

The illustrative receptacle 20 includes an internal annular rib 92 which provides an attachment structure for engaging a connector insert (not shown). In the illustrative embodiment, the insert is a disk having a thickness greater than the thickness of the internal annular rib 92 and a groove in its periphery adapted to accept the annular rib 92. The insert is made from materials having enough flexibility to allow it to snap over the annular rib 92. In the illustrative embodiment, the insert is further secured to the receptacle 20 by application of glue and/or epoxy therebetween. Persons skilled in the art should appreciate that many alternative methods can be used to secure a connector insert to a receptacle 20. For example, a pair of ribs could be used to support a flexible insert therebetween. Alternatively a combination of snaps and ribs in the receptacle 20 could be used to secure a rigid insert therebetween.

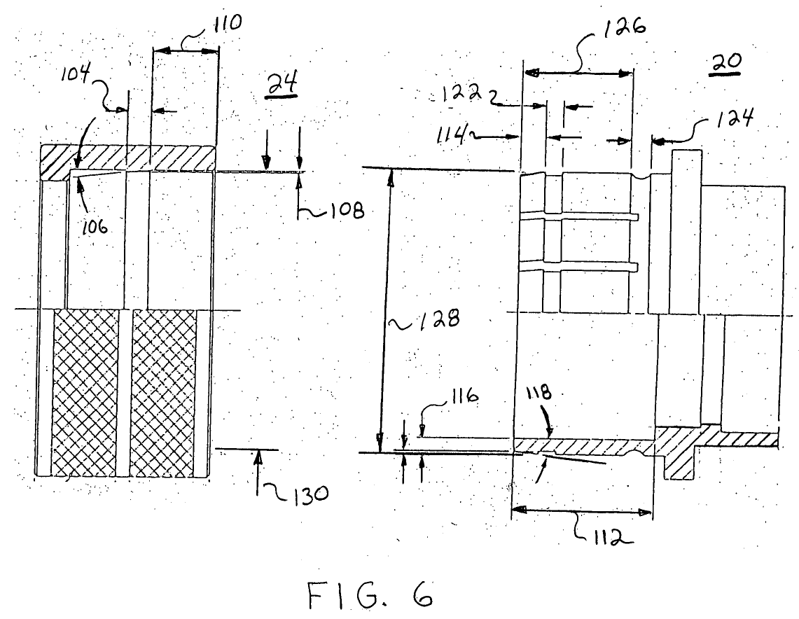

Exemplary embodiments of the invention provide a connection between conduits wherein the connection is impossible or very difficult to manually disconnect but which must disconnect upon reaching a critical extraction force to protect connected equipment from damage. The exemplary embodiments requires an insertion/engagement force below a first threshold for manual insertion and an extraction/disengagement force above a second threshold to prevent manual disengagement but below a third threshold to allow disengagement before connected equipment is damaged by tension in the connected conduit. The engagement and disengagement forces can be controlled by adjustment of certain component dimensions. Certain component dimensions which provide desired engagement and disengagement forces are described with reference to FIG. 6.

In a first exemplary embodiment, a connector receptacle 20 having a radial array of snap arms with an outside diameter 128 of 1.00 inches is made from aluminum alloy 2001-T3/451. A mating coupling sleeve 24 having an inside diameter 130 of 1.008 inches is also made from aluminum alloy 2001-T3/451. The radial array of snap arms is formed by providing 12 longitudinal slots between snap arms. The slots are 0.045 inches wide, 0.450 inches long and 30 degrees apart. The sleeve ramp length 104 is 0.125 inches. The sleeve ramp angle 106 is 6 degrees. The sleeve step depth 108 is 0.010 inches. The sleeve pre-engagement length 110 is 0.180 inches. The snap arm length 112 is 0.595 inches. The snap arm ramp length 114 is 0.105 inches. The snap arm thickness 116 is 0.082 inches. The snap arm ramp angle 118 is 7 degrees. The snap arm step depth 120 is 0.015 inches. The annular groove length 122 is 0.094 inches. The o-ring groove length 124 is 0.100 inches. The o-ring groove position 126 is 0.400 inches.

With a set of typical connector pins installed, the first exemplary embodiment provides an engagement force between said receptacle and said engagement sleeve of about 25 lbs and a disengagement force between said receptacle and said coupling sleeve of about 80 lbs.

In a second exemplary embodiment, a connector receptacle 20 having a radial array of snap arms with an outside diameter 128 of 1.50 inches is made from aluminum alloy 2001-T3/451. A mating coupling sleeve 24 having an inside diameter 130 of 1.50 inches is also made from aluminum alloy 2001-T3/451. The radial array of snap arms is formed by providing 12 longitudinal slots between snap arms. The slots are 0.045 inches wide, 0.650 inches long and 30 degrees apart. The sleeve ramp length 104 is 0.125 inches. The sleeve ramp angle 106 is 6 degrees. The sleeve step depth 108 is 0.015 inches. The sleeve pre-engagement length 110 is 0.365 inches. The snap arm length 112 is 0.763 inches. The snap arm ramp length 114 is 0.133 inches. The snap arm thickness 116 is 0.085 inches. The snap arm ramp angle 118 is 7 degrees. The snap arm step depth 120 is 0.015 inches. The annular groove length 122 is 0.094 inches. The o-ring groove length 124 is 0.100 inches. The o-ring groove position 126 is 0.600 inches.

With a set of typical connector pins installed, the second exemplary embodiment also provides an engagement force between said receptacle and said engagement sleeve of about 25 lbs and a disengagement force between said receptacle and said coupling sleeve of about 80 lbs.

Persons having ordinary skill in the art should understand that standard manufacturing dimensional tolerances can be used in the exemplary embodiments. For example, most exemplary dimensions should be maintained to within 0.003 inches.

Although the present invention is described as having a mounting flange extending from a connector receptacle, persons skilled in the art should appreciate that various alternative mounting features can be used within the scope of the present invention to secure the receptacle and/or a connector plug to connected equipment. For example, the receptacle could alternatively include a threaded body portion for mating to connected equipment or could be press fit or snapped thereto according to alternative embodiments of the present invention.

Although the present invention is described as including a coupling sleeve that is fixed relative to a connector plug, persons skilled in the art should appreciate that alternative embodiments of the present invention could include a coupling sleeve that has some longitudinal travel relative to the connector plug.

Although the present invention is described primarily in terms of a means of connecting electrical conductors, persons skilled in the art should appreciate that various types of connections can also be provided within the scope of the present invention. For example, alternative embodiments of the present invention can provide connections to electrical wires, coaxial conductors, optical fibers and fiber optic cables and the like. At least one exemplary embodiment of the invention connects 20 electrical contacts for 20 AWG wire, 5 electrical contacts for 18 AWG wire, 1 coaxial cable and 2 fiber optic conduits in a single connector system having the desired engagement/disengagement forces.

Although the invention has been shown and described with respect to exemplary embodiments thereof, various other changes, omissions and additions in the form and detail thereof may be made therein without departing from the spirit and scope of the invention.

1. A connector system comprising:
a receptacle having an annular wall defining a proximal opening, a distal opening and a central cavity extending from said proximal opening to said distal opening along a longitudinal axis;
a mounting portion extending transversely from said annular wall;
a radial array of snap arms formed in said annular wall and extending distally around said distal opening; and
a coupling sleeve having an annular wall defining a proximal opening, a distal opening a central cavity extending from said proximal opening to said distal opening along a longitudinal axis, an internal annular groove defining a step portion adapted for engagement with said snap arms.

2. The connector system according to claim 1 wherein:
said receptacle further comprises an insert retaining portion in said receptacle extending from said annular wall into said central cavity; and
said coupling sleeve further comprises an insert retaining portion extending from said annular wall into said central cavity.

3. The connector system according to claim 1 further comprising:
a pin insert durably mounted in said central cavity of said receptacle; and
a socket insert durably mounted in said central cavity of said mounting sleeve.

4. The connector system according to claim 3 wherein said pin insert includes a set of connector pins protruding from a planar substrate;
and said socket insert includes a set of sockets protruding from a planar substrate and arranged for receiving said set of connector pins.

5. The connector system according to claim 3 wherein force to overcome snap forces and friction for engagement of said receptacle and pin insert to said coupling sleeve and socket insert are substantially less than forces to overcome snap forces and friction for disengagement of said receptacle and pin insert from said coupling sleeve and socket insert.

6. The connector system according to claim 3 wherein force to overcome snap forces and friction for engagement of said receptacle and pin insert to said coupling sleeve and socket insert are suitable for manual engagement therebetween and forces to overcome snap forces and friction for disengagement of said receptacle and pin insert from said coupling sleeve and socket insert are high enough to prevent manual disengagement therebetween.

7. The connector system according to claim 3 wherein force to overcome snap forces and friction for engagement of said receptacle and pin insert to said coupling sleeve and socket insert is about between 15 lbs and 30 lbs and forces to overcome snap forces and friction for disengagement of said receptacle and pin insert from said coupling sleeve and socket insert is about between 75 and 110 lbs.

8. The connector system according to claim 1 further comprising an annular groove extending into said snap arms and adapted to accept an o-ring.

9. The connector system according to claim 8 wherein said o-ring groove depth is adapted to adjust snap engagement/extraction forces.

10. The connector system according to claim 1 wherein said snap arms include tapered lead-in surface such that the distal end external diameter of said radial array of snap arms is less than the proximal opening of said coupling sleeve.

11. The connector system according to claim 1 wherein said receptacle is made from aluminum alloy.

12. A connector system comprising:
a receptacle having an annular wall defining a proximal opening, a distal opening and a central cavity extending from said proximal opening to said distal opening along a longitudinal axis;
a mounting portion extending transversely from said annular wall;
a radial array of snap arms formed in said annular wall and extending distally around said distal opening;
an insert retaining portion in said receptacle extending from said annular wall into said central cavity;
a coupling sleeve having an annular wall defining a proximal opening, a distal opening a central cavity extending from said proximal opening to said distal opening along a longitudinal axis, an internal annular groove defining a step portion adapted for engagement with said snap arms and an insert retaining portion extending from said annular wall into said central cavity;
a pin insert durably mounted in said central cavity of said receptacle; and
a socket insert durably mounted in said central cavity of said mounting sleeve.

13. The connector system according to claim 12 wherein said pin insert includes a set of connector pins protruding from a planar substrate;
and said socket insert includes a set of sockets protruding from a planar substrate and arranged for receiving said set of connector pins;
wherein force to overcome snap forces and friction for engagement of said receptacle and pin insert to said coupling sleeve and socket insert is about between 15-30 lbs and forces to overcome snap forces and friction for disengagement of said receptacle and pin insert from said coupling sleeve and socket insert is about between 75 and 110 lbs.

14. A method of making a connector system comprising the steps of:
providing a receptacle having a mounting portion and a plurality of snap arms extending distally therefrom;
durably installing a pin/socket insert in said receptacle;
providing a coupling sleeve adapted from snapping over said plurality of snap arms; and
durably installing a socket/pin insert in said coupling sleeve.

15. The method according to claim 14 further comprising providing particular engagement/disengagement forces between said receptacle and said coupling sleeve by adjusting parameters of said snap arms selected from the group consisting of width, base thickness, ramp-depth, and step depth.

16. The method according to claim 14 further comprising providing particular engagement/disengagement forces between said receptacle and said coupling sleeve by controlling the depth of an o-ring groove wherein said o-ring groove intersects said snap arms.

17. The method according to claim 14 further comprising designing said snap arms and mating portions of said coupling sleeve to provide an engagement force between said receptacle and said engagement sleeve of about 25 lbs and a disengagement force between said receptacle and said coupling sleeve of about 80 lbs.

18. A method of protecting connected equipment connected by electrical, hydraulic or pneumatic conduit comprising the steps of:
fixedly mounting a receptacle on said equipment, said receptacle permanently holding a first set of conduit terminals;
durably installing a mating set of conduit terminals to a mounting sleeve;
wherein said mounting sleeve is configured as a snap ring adapted to snap fit to said receptacle with an engagement force low enough for manual installation of said sleeve to said receptacle and a disengagement force exceeding a manually achievable force.

19. The method according to claim 18 wherein said disengagement force exceeds the weight of said cables and equipment associated with said mating set of conduit terminals.
